(19) United States
(12) Patent Application Publication
(10) Pub. No.: US 2007/0147069 A1
(43) Pub. Date: Jun. 28, 2007

(54) Backlight module having a light guide bar and liquid crystal display using the same

(75) Inventors: Liao-Liao Zhu, Shenzhen (CN); Xiong-Biao Huang, Shenzhen (CN); Zhi-Feng Fu, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/641,980

(22) Filed: Dec. 19, 2006

(30) Foreign Application Priority Data
Dec. 23, 2005 (TW) 94146370

(51) Int. Cl. F21V 7/04

(52) U.S. Cl. 362/600

(57) ABSTRACT

An exemplary liquid crystal display (2) has a liquid crystal panel (50) and a backlight module (20) being disposed under the liquid crystal panel, the backlight module has a light guide plate (21), and a light source having at least one point light source (23), at least one light guide bar (22) transmitting light beams from the at least one point light source, and a reflector (24) reflecting light beams from the at least one light guide bar into the light guide plate.

### FIELD OF THE INVENTION

The present invention relates to backlight modules and the liquid crystal displays, and especially to backlight modules and the liquid crystal displays having a light guide bar.

### BACKGROUND

Liquid crystal displays are commonly used as display devices for compact electronic apparatuses, because they not only provide good quality images with little power but also are very thin. The liquid crystals in a liquid crystal display do not emit any light themselves. The liquid crystals have to be lit by a light source so as to clearly and sharply display text and images. Thus, a backlight module for an LCD is generally needed.

Referring to FIG. 4, a related backlight module 10 includes a light guide plate (LGP) 11 and a light source 12. The light source 12 is an L-shaped light source, which has a bent region 121 connecting two linear regions (not labeled). The LGP 11 is in a shape of rectangle, which has two light incident surfaces 111, a light emitting surface 112 connecting with the two light incident surfaces 111, and a bottom surface 113 opposite to the light emitting surface 112, and a corner 114 at the intersection of the two light incident surfaces 111. The light source 12 is disposed adjacent to the two adjacent incident surfaces 111, and the bent region 121 is opposite the corner of the LGP 11. Light beams from the light source 12 are directed into the LGP 11 through the two incident surfaces 111. In assembly, the bent region 121 faces the corner 114. Because the corner 114 has a point, the operator needs special carefulness in the process of assembling the light source 12 to the LGP 11 for preventing the point of the corner 121 from destroying the bent region 114 of the light source 12. In addition, a gap between the light source 12 and the two incident surfaces 111 is larger because the corner. Thus, the backlight module 10 has a larger size.

What is needed, therefore, is a safe backlight module and liquid crystal display having a high reliability.

### SUMMARY

In an exemplary example, a backlight module is provided. The backlight module a light guide plate, and a light source having at least one point light source, at least one light guide bar transmitting light beams from the at least one point light source, and a reflector reflecting light beams from the at least one light guide bar into the light guide plate.

In another exemplary example, a liquid crystal display is provided. The exemplary liquid crystal display has a liquid crystal panel and a backlight module being disposed under the liquid crystal panel, the backlight module has a light guide plate, and a light source having at least one point light source, at least one light guide bar transmitting light beams from the at least one point light source, and a reflector reflecting light beams from the at least one light guide bar into the light guide plate.

Other advantages and novel features will become more apparent from the following detailed description of preferred embodiments when taken in conjunction with the accompanying drawings, in which:

### BRIEF DESCRIPTION OF THE DRAWINGS

FIG. 1 is a schematic view of a liquid crystal display, which has a backlight module and a liquid crystal panel provided on the backlight module;

FIG. 2 is an exploded, isometric view showing the backlight module in FIG. 1;

FIG. 3 is an exploded, isometric view showing a backlight module of a liquid crystal display according to a second embodiment of the present invention; and

FIG. 4 is a schematic, isometric view of a conventional backlight module.

### DETAILED DESCRIPTION OF PREFERRED EMBODIMENTS

Reference will now be made to the drawings to describe the preferred embodiments in detail.

Referring to FIG. 1, a liquid crystal display 2 according to a first embodiment of the present invention has a backlight module 20 and a liquid crystal panel 50 provided on the backlight module 20.

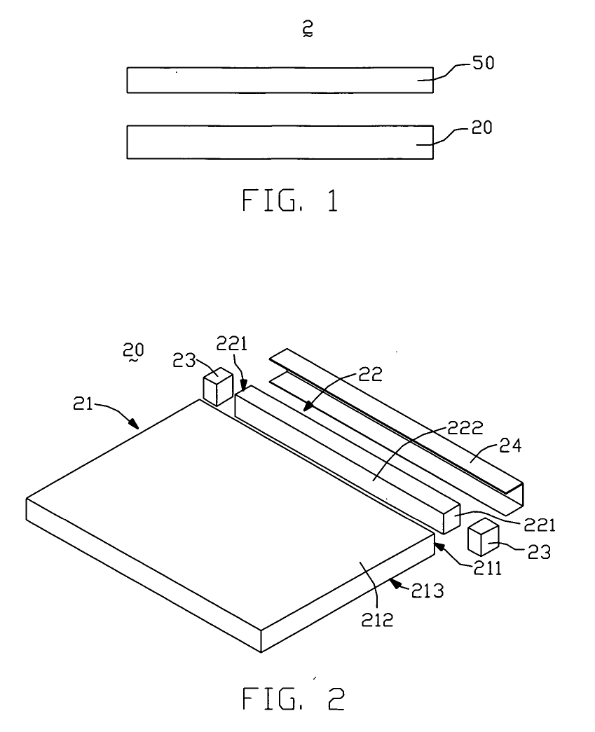

Referring to FIG. 2, the backlight module 20 has a light guide plate (LGP) 21 and a strip-shaped light source (not labeled). The strip-shaped light source has a light guide bar 22, two point light sources 23 and a reflector 24.

The LGP 21 includes a bottom surface 213, a light emitting surface 212 opposite to the bottom surface 213, a light incident surface 211 orthogonal connected with the bottom surface 213 and the light emitting surface 212. The LGP 300 is in a shape of rectangular.

The light guide bar 22 is in a shape of rectangular, which has two light incident surfaces 221, opposite to each other, and a light emitting surface 222 orthogonal connected with the two light incident surfaces 221.

In assembly, the two point light sources 23 are respectively provided adjacent to the two light incident surfaces 221 of the light guide bar 22. The light guide bar 22 is disposed adjacent to the light incident surface 211 of the light guide plate 21, the light emitting surface 222 of the light guide bar 22 facing the light incident surface 211 of the light guide plate 21. The reflector 24 surrounds three sides of the light guide bar 22, which reflects light beams leaking from the light guide bar 22 into the light guide bar 22 again.

When voltage is provided to the two light sources 23, light beams from the two light sources 23 enter into the light guide bar 22. Light beams transmit in the light guide bar 22 and are reflected by the reflector 24 into the light guide plate 21 from the light emitting surface 222 of the light guide bar 22 to the light incident surface 211 of the light guide plate 21. The light guide bar 22 uniforms light beam before it transmits into the light guide plate 21 through the light incident surface 211. After the light beams transmit into the light guide plate 21, the light guide plate 21 functions to change a direction of propagation of light beams emitted from the light guide bar 22 and introduced into the light guide plate 21, from a direction roughly parallel to the emission face 212 of the light guide plate 21 to a direction perpendicular to the emission face 212 by the diffusion of the dot patterns (not labeled) on the bottom surface 213. That is, the light guide plate 21 effectively changes the linear light source(s) into a surface light source, for evenly illuminating a whole display screen of the LCD panel 50.

The light guide plate 21 and the light guide bar 22 can be made from Polymethyl Methacrylate (PMMA) or Polycarbonate (PC) by the injection molding method. The two point light sources 23 also can be replaced by one point light source, which are light emitting diodes (LEDs).

The LCD 2 utilizes the point light sources 23 cooperating with the light guide bar 22 to replace conventional cold cathode fluorescent lamp (CCFL). Because the light emitting diodes have the advantages of long usage life time, high response time, high reliability and safe, comparing to the cold cathode fluorescent lamp (CCFL), the LCD 2 can attain long life time, high response time, high reliability and safe backlight module 20.

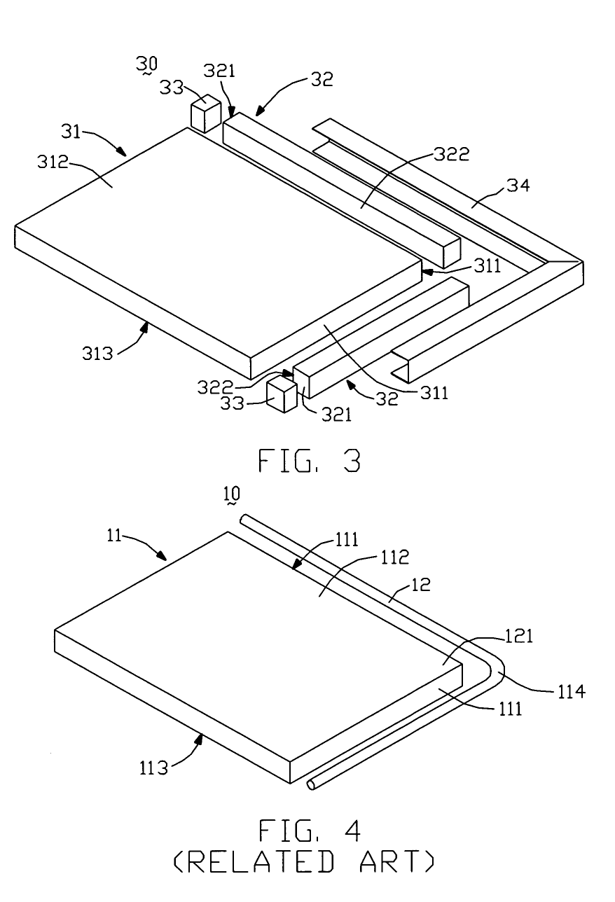

Referring to FIG. 3, a backlight module 30 of a liquid crystal display according to a second embodiment is shown. The backlight module 30 has a light guide plate (LGP) 31 and an L-shaped light source (not labeled). The L-shaped light source has two light guide bars 32, two point light sources 33 and a reflector 34.

The LGP 31 includes a bottom surface 313, a light emitting surface 312 opposite to the bottom surface 313, two light incident surfaces 311 orthogonal connecting with the bottom surface 313 and the light emitting surface 312. The LGP 300 is in a shape of rectangular. The two light incident surfaces 311 connect at one end, are configured in an L shape.

The two light guide bars 32 each are in a shape of rectangular. Each has a light incident surface 321, and a light emitting surface 322 orthogonal connected with the light incident surface 321.

In assembly, the two point light sources 33 are respectively provided adjacent to the two light incident surfaces 321 of the two light guide bar 32. The two light guide bar 22 are respective disposed adjacent to the two light incident surfaces 311 of the light guide plate 31, light emitting surfaces 322 of the two light guide bars 32 respectively facing the light incident surface 311 of the light guide plate 31. The reflector 34 being L-shaped surrounds three sides of the two light guide bars 32, which reflects light beams leaking from the light guide bar 32 into the light guide bar 32 again.

When voltage is provided to the two light sources 33, light beams from the two light sources 33 respectively enter into the two light guide bars 322 from two light incident surfaces 321. Light beams transmit in the light guide bars 32 and are reflected by the reflector 34 into the light guide plate 31. The two light guide bars 32 uniform light beams before they transmit into the light guide plate 31 through the light incident surfaces 311. After the light beams transmit into the light guide plate 31, the light guide plate 31 functions to change a direction of propagation of light beams emitted from the light guide bars 32 and introduced into the light guide plate 31, from a direction roughly parallel to the emission face 312 of the light guide plate 31 to a direction perpendicular to the emission face 312 by the diffusion of the dot patterns (not labeled) on the bottom surface 313. That is, the light guide plate 31 effectively changes the linear light source(s) into a surface light source, for evenly illuminating a whole display screen of the LCD.

The light guide plate 31 and the light guide bar 32 can be made from Polymethyl Methacrylate (PMMA) or Polycarbonate (PC) by the injection molding method. The two point light sources 33 also can be replaced by one point light source, which are light emitting diodes (LEDs).

The backlight module 30 utilize two point light sources 33 cooperating with two light guide bars 32 to replace conventional L-shaped cold cathode fluorescent lamp (CCFL). Because the light emitting diodes have the advantages of long usage life time, high response time, high reliability and safe, comparing to the cold cathode fluorescent lamp (CCFL), the backlight module 30 can attain long life time, high response time, high reliability and safe characteristics.

In alternative changes, the L-shaped light source can be a U-shaped light source, which has three light sources and three light guide bars connecting, each light source being disposed at one end of the light guide bar.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight module, comprising:
a light guide plate, and
a light source having at least one point light source, at least one light guide bar transmitting light beams from the at least one point light source, and a reflector reflecting light beams from the at least one light guide bar into the light guide plate.

2. The backlight module as claimed in claim 1, wherein the point light source is disposed at one end of the light guide bar.

3. The backlight module as claimed in claim 1, wherein the light guide plate has at least one incident surface, an emitting surface orthogonally connected with the incident surface, and a bottom surface facing the emitting surface.

4. The backlight module as claimed in claim 3, wherein light guide bar is disposed adjacent to the incident surface of the light guide plate.

5. The backlight module as claimed in claim 1, wherein the light source is strip shaped, which has one point light source and one light guide bar.

6. The backlight module as claimed in claim 3, wherein the light source is strip shaped, which has two point light sources and one light guide bar, the two point light sources being disposed at two ends of the light guide bar.

7. The backlight module as claimed in claim 6, wherein the light guide plate has one incident surface, the light guide bar being disposed adjacent the incident surface.

8. The backlight module as claimed in claim 3, wherein the light source is L-shaped, which has two point light sources and two light guide bars, the two point light sources being respectively disposed at one end of the two light guide bars, and the two light guide bars being configured to L-shaped.

9. The backlight module as claimed in claim 6, wherein the light guide plate has two incident surfaces, connecting at one end, the two light guide bars being respectively disposed adjacent the two incident surfaces.

10. The backlight module as claimed in claim 3, wherein the light source is U-shaped, which has three point light sources and three light guide bars, the three point light sources being respectively disposed at one end of the three light guide bars.

11. A liquid crystal display, comprising:
a liquid crystal panel and a backlight module being disposed under the liquid crystal panel, the backlight module comprising:
a light guide plate, and
a light source having at least one point light source, at least one light guide bar transmitting light beams from the at least one point light source, and a reflector reflecting light beams from the at least one light guide bar into the light guide plate.

12. The liquid crystal display as claimed in claim 11, wherein the point light source is disposed at one end of the light guide bar.

13. The liquid crystal display as claimed in claim 11, wherein the light guide plate has at least one incident surface, an emitting surface orthogonally connected with the incident surface, and a bottom surface facing the emitting surface.

14. The liquid crystal display as claimed in claim 13, wherein light guide bar is disposed adjacent to the incident surface of the light guide plate.

15. The liquid crystal display as claimed in claim 11, wherein the light source is strip shaped, which has one point light source and one light guide bar.

16. The liquid crystal display as claimed in claim 13, wherein the light source is strip shaped, which has two point light sources and one light guide bar, the two point light sources being disposed at two ends of the light guide bar.

17. The liquid crystal display as claimed in claim 16, wherein the light guide plate has one incident surface, the light guide bar being disposed adjacent the incident surface.

18. The liquid crystal display as claimed in claim 13, wherein the light source is L-shaped, which has two point light sources and two light guide bars, the two point light sources being respectively disposed at one end of the two light guide bars, and the two light guide bars being configured to L-shaped.

19. The liquid crystal display as claimed in claim 13, wherein the light source is U-shaped, which has three point light sources and three light guide bars, the three point light sources being respectively disposed at one end of the three light guide bars.

20. A backlight module, comprising:
a light guide plate, and
a light source having at least one point light source, at least one light guide bar having an emitting face confronting an incident face of the light guide plate, most light beams derived from the at least one point light source entering the light guide plate via said light guide bar; wherein
the light source is located at a lengthwise end of said light guide bar.
